(19) United States
(12) Patent Application Publication
(10) Pub. No.: US 2021/0023785 A1
(43) Pub. Date: Jan. 28, 2021

(54) CONTROLLING MOISTURE CONTENT OF BUILD MATERIAL IN A THREEDIMENSIONAL (3D) PRINTER

(71) Applicant: HEWLETT-PACKARD DEVELOPMENT COMPANY, L.P., Spring, TX (US)

(72) Inventors: Luke Sosnowski, Vancouver, WA (US); Justin M. Roman, Vancouver, WA (US); David R. Otis, JR., Corvallis, OR (US); Terry Lambright, Corvallis, OR (US)

(21) Appl. No.: 16/607,739

(22) PCT Filed: Apr. 6, 2018
(86) PCT No.: PCT/US18/26564

§ 371 Date: Oct. 24, 2019

(51) Int. Cl. B29C 64/255; B29C 64/364; B29C 64/314

(52) U.S. Cl. CPC B29C 64/255; B33Y 30/00; B29C 64/314; B29C 64/364

(57) ABSTRACT

Techniques for controlling moisture content of build material in a three-dimensional printer are provided. The system includes a vessel to supply the build material into a build material conveying system. The vessel includes an air inlet to receive a flow of air to fluidize the build material. The system also includes an air conditioner to control the humidity of the air and provide a controlled level of moisture content to the build material.

### BACKGROUND

Three-dimensional (3D) printing may produce a 3D object by adding successive layers of build material, such as powder, to a build platform, then selectively solidifying portions of each layer under computer control to produce the 3D object. The build material may be powder, or powder-like material, including metal, plastic, ceramic, composite material, and other powders. In some examples the powder may be formed from, or may include, short fibers that may, for example, have been cut into short lengths from long strands or threads of material. The objects formed can be various shapes and geometries, and may be produced using a model, such as a 3D model or other electronic data source. The fabrication may involve laser melting, laser sintering, heat sintering, electron beam melting, thermal fusion, and so on. The model and automated control may facilitate the layered manufacturing and additive fabrication. The 3D printed objects may be prototypes, intermediate parts and assemblies, as well as end-use products. Product applications may include aerospace parts, machine parts, medical devices, automobile parts, fashion products, and other applications.

### DESCRIPTION OF THE DRAWINGS

Certain examples are described in the following detailed description and in reference to the following drawings.

FIG. 1 is a drawing of a 3D printer, in accordance with examples.

FIG. 2 is a schematic diagram of a 3D printer, in accordance with examples.

FIG. 3 is a block diagram of a 3D printer, in accordance with examples.

FIG. 4 is a drawing of a build material vessel, in accordance with examples.

FIG. 5 is an air intake system for a 3D printer, in accordance with examples.

FIG. 6 is a block diagram of summarizing a method for operating a 3D printer, in accordance with examples.

### DETAILED DESCRIPTION

Three dimensional printers may form 3D objects from different kinds of powder or powder-like build material. The build material can be, for example, a semi-crystalline thermoplastic material, a metal material, a plastic material, a composite material, a ceramic material, a glass material, a resin material, or a polymer material, among other types of build material. Further, the build material may include multi-layer structures wherein each particle comprises multiple layers. In some examples, a center of a build material particle may be a glass bead, having an outer layer comprising a plastic binder to agglomerate with other particles for forming the structure. Other materials, such as fibers, may be included to provide different properties, for example, strength.

An example 3D printer may include supply stations to facilitate handling of the build material. The supply stations provide for the addition of new or recycle build material to an internal or integrated material handling system from build material containers that are inserted into the supply stations. The material handling system may mix recycle material and new material to provide a build material mix to be used in a 3D printing process. Some 3D printers also provide for the recovery of excess or non-solidified build material at the end of a 3D printing process. The recovered material may be held in the printer for use in further build processes. In some cases, the recovered material may be moved into a build material container which may then be removed from the 3D printer for storage, recycling, or for later use.

It may be desirable at times to change the moisture content of the build material. For example, if the build material becomes too dry, the build material may be become electrically charged as it comes into frictional contact with other materials, a phenomenon known as the triboelectric effect. If the build material becomes electrically charged, transport of the build material may not flow in a consistent manner, and charged powder may stick to other surfaces due to electrostatic attraction. Thus, it may be desirable at times to add moisture content to the build material to reduce the triboelectric effect and prevent charge accumulation. However, if there is too much moisture content in the build material, the build material may tend to clump together and inhibit the flow of the build material through the conveying system of the 3D printer.

The present disclosure describes techniques for controlling the moisture content of the build material. An example of a 3D printer in accordance with the disclosed techniques may include a build material vessel such as a feed hopper. The hopper is configured to receive a flow of air from the bottom of the hopper through a membrane, mesh, or screen to fluidize the build material in preparation for transport through the printer's feed system. Additionally, the humidity of the air flowing into the hopper is controlled to either increase or decrease the moisture content of the build material. The disclosed techniques ensures that the build material has a uniform and precise moisture content level that avoids triboelectric charging of the powder while also ensuring that the powder will flow freely through the build material conveying system of the three dimensional printer.

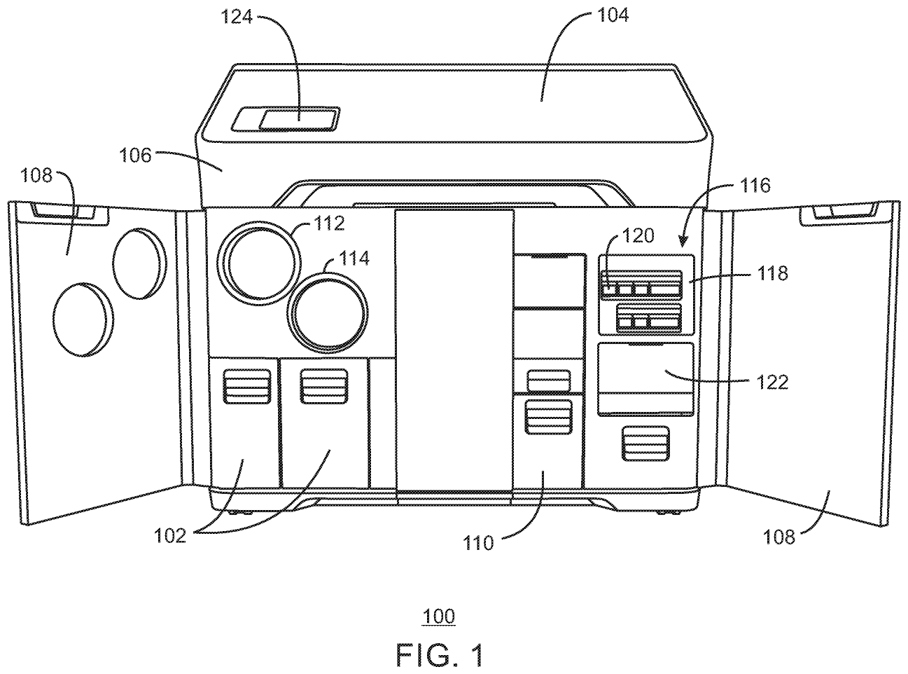

FIG. 1 is a 3D printer 100, in accordance with examples. The 3D printer 100 may be used to generate a 3D object from a build material, for example, on a build platform. The build material may be a powder, and may include a plastic, a metal, a glass, or a coated material, such as a plastic-coated glass powder, among others. It will be appreciated that the 3D printer 100 shown in FIG. 1 is one example of a 3D printer that can incorporate the techniques described herein for controlling the moisture content of the build material.

The printer 100 may have covers or panels over compartments 102 for internal material vessels that hold build material. The material vessels may discharge build material through feeders into an internal conveying system for the 3D printing. The printer 100 may have a controller to adjust operation of the feeders to maintain a desired composition of build material including a specified ratio of materials in the build material. The internal material vessels may be removable via user-access to the compartments 102. The printer 100 may have a housing and components internal to the housing for handling of build material. The printer 100 has a top surface 104, a lid 106, and doors or access panels 108. The access panels 108 may be locked during operation of the 3D printer 100. The printer 100 may include a compartment 110 for an additional internal material vessel such as a recovered material vessel that recovers unfused or excess build material from a build enclosure of the printer 100.

As described in detail herein, build material may be added or removed from the 3D printer through build material containers that are horizontally inserted into supply stations. The supply stations may include a new supply station 112 for the addition of new build material, and a recycle supply station 114 for the addition of recycled build material. As described in examples, the recycle supply station 114 may also be used to offload recovered build material, for example, from the recovered material vessel. In one example, a single supply station may be provided which may be used for both adding new build material and for removing recycled build material from the printer.

In some examples, the 3D printer 100 may use a print liquid for use in a selective fusing process, or other purposes, such as decoration. For examples of a 3D printer 100 that employ a print liquid, a print-liquid system 116 may be included to receive and supply print liquid for the 3D printing. The print-liquid system 116 includes a cartridge receiver assembly 118 to receive and secure removable print-liquid cartridges 120. The print liquid system 116 may include a reservoir assembly 122 having multiple vessels or reservoirs for holding print liquid collected from the print liquid cartridges 120 inserted into the cartridge receiver assembly 118. The print liquid may be provided from the vessels or reservoirs to the 3D printing process, for example, to a print assembly or printbar above a build enclosure and build platform.

The 3D printer 100 may also include a user control panel or interface 124 associated with a computing system or controller of the printer 100. The control interface 124 and computing system or controller may provide for control functions of the printer 100. The fabrication of the 3D object in the 3D printer 100 may be under computer control. A data model of the object to be fabricated and automated control may direct the layered manufacturing and additive fabrication. The data model may be, for example, a computer aided design (CAD) model, a similar model, or other electronic source. The computer system, or controller, may have a hardware processor and memory. The hardware processor may be a microprocessor, CPU, ASIC, printer control card, or other circuitry. The memory may include volatile memory and non-volatile memory. The computer system or controller may include firmware or code, e.g., instructions, logic, etc., stored in the memory and executed by the processor to direct operation of the printer 100 and to facilitate various techniques discussed herein.

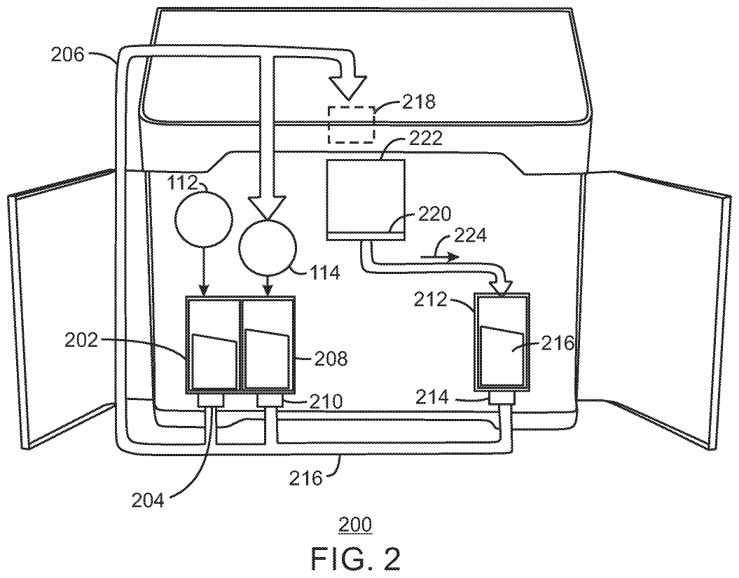

FIG. 2 is a schematic diagram of a 3D printer 200, in accordance with examples. Like numbered items are as described with respect to FIG. 1. It will be appreciated that the 3D printer 200 shown in FIG. 2 is one example of a 3D printer that can incorporate the techniques described herein for controlling the moisture content of the build material.

The printer 200 may include a recycle material vessel 208 to discharge recycle build material through a recycle feeder 210 to the conveying system 206. The printer 200 may have a controller to adjust operation of the feeders 204, 210 to maintain a composition and discharge rate of the build material for the 3D printing. Further, the printer 200 may include a recovered material vessel 212 to discharge recovered material 216 through a recovery feeder 214 into the conveying system 206. The conveying system 206 may transport the build material to a dispense vessel 218 which may supply build material for 3D printing. In the illustrated example, the dispense vessel 218 is disposed in an upper portion of the 3D printer 200. Moreover, although the conveying system 206 for the build material is depicted outside of the 3D printer 200 for clarity in this schematic view, the conveying system 206 is internal to the housing of the printer 200.

The 3D printer 200 may form a 3D object from the build material on a build platform 220 associated with a build enclosure 222. The 3D printing may include selective layer sintering (SLS), selective heat sintering (SHS), electron beam melting (EBM), thermal fusion, and fusing agent, or other 3D printing and additive manufacturing (AM) technologies to generate the 3D object from the build material. According to one example, a suitable fusing agent may be an ink-type formulation comprising carbon black, such as, for example, the fusing agent formulation commercially known as V1Q60Q “HP fusing agent” available from HP Inc. In one example such a fusing agent may additionally comprise an infra-red light absorber. In one example such an ink may additionally comprise a near infra-red light absorber. In one example such a fusing agent may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc.

Recovered build material 224, for example, non-solidified or excess build material, may be recovered from the build enclosure 222. The recovered build material 224 may be treated and returned to the recovered material vessel 212. Further, the printer 200 may include a new supply station 112 and a recycle supply station 114 to hold build material containers inserted by a user along a horizontal, or generally horizontal, axis. The supply stations 112 and 114 may provide new or recycled build material for the 3D printing to the new and recycle material vessels 202 and 208, respectively. Further, the conveying system 206 may return recovered material 216 to the recycle supply station 114. The recovered material 216 may be offloaded by being added to a build material container inserted in the recycle supply station 114, or may be diverted through the recycle supply station 114 to the recycle material vessel 208.

Lastly, as noted, the build material including the first material and the second material may be powder. A powder may be a granular material with a narrow size distribution, such as beads, or other shapes of small solids that may flow and be conveyed in an air stream. As used herein, the term “powder” as build material can, for example, refer to a powdered, or powder-like, material which may be layered and sintered via an energy source or fused via a fusing agent, or a fusing agent and energy source in a 3D printing job. In some examples, the build material may be formed into a shape using a chemical binder, such as a solvent binder or a reaction promoter. The build material can be, for example, a semi-crystalline thermoplastic material, a metal material, a plastic material, a composite material, a ceramic material, a glass material, a resin material, or a polymer material, among other types of build material.

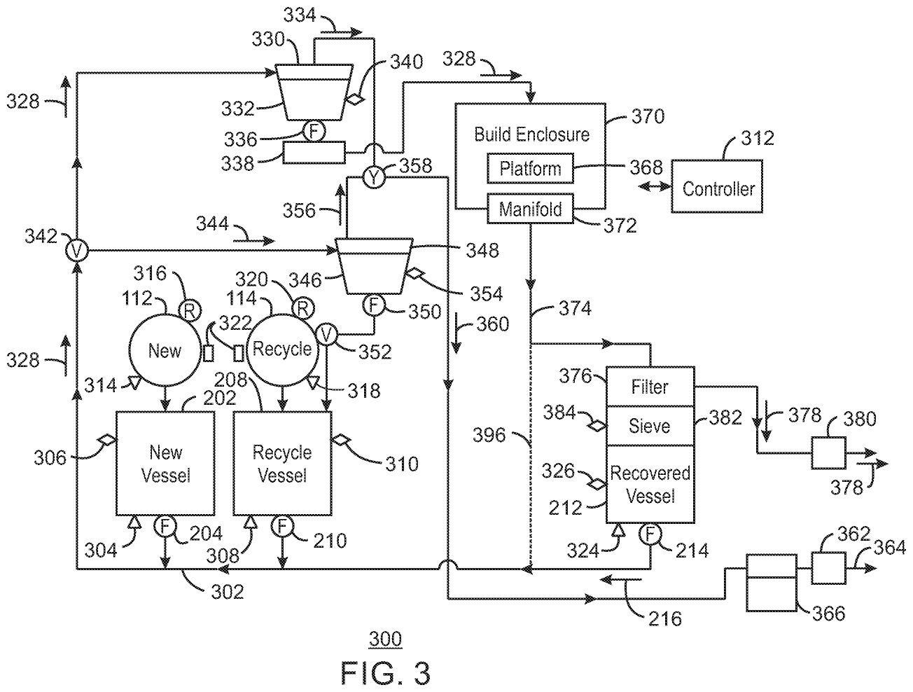

FIG. 3 is a block diagram of a 3D printer 300, in accordance with examples. Like numbered items are as described with respect to FIGS. 1 and 2. It will be appreciated that the 3D printer 300 shown in FIG. 3 is one example of a 3D printer that can incorporate the techniques described herein for controlling the moisture content of the build material.

As shown in this drawing, material flows are shown by labelled arrows placed along conveying lines or conduits, which may be separately labeled. In this example, the 3D printer 300 may have a new material vessel 202 that discharges new material through a feeder 204, such as a rotary feeder, auger, or screw feeder, into a first conveying system 302, which may be a pneumatic conveying system. The feeder 204 may drop the new material into a conduit of the conveying system 302. The feeder 204 may meter or regulate material discharge or otherwise facilitate dispensing of the desired amount of new material from the new material vessel 202 into the first conveying system 302. In addition, the 3D printer 300 may include a recycle material vessel 208 that discharges recycle material through a feeder 210 into the first conveying system 302.

The new material vessel 202 may have a weight sensor 304 and a fill level sensor 306. Likewise, the recycle material vessel 208 may have a weight sensor 308 and a fill level sensor 310. A controller 312 of the printer 300 may adjust operation of the feeders 204 and 210 in response to indications of material discharge amount or rate provided by the weight sensors 304 and 308. The controller may adjust operation of the feeders 204 and 210 to maintain a desired ratio of new material to recycle material. In examples described herein, the controller 312 may control the dispensing of build material from a build material container, or the offloading of build material to a build material container.

The 3D printer 300 may include a new supply station 112 to hold a build material container for adding new build material in a cylindrical cage, along a horizontal axis. The new material vessel 302 may receive new build material from the build material container held by the new supply station 112. As described herein, the new supply station 112 may include several sensors and actuators to determine if a build material container is present, and control the dispensing of build material from the build material container. The sensors may include a weighing device 314 that may be used to determine the weight of the new supply station 112 and the build material container. The actuators may include a motor 316 to rotate the cylindrical cage in a first angular direction to dispense build material to the new material vessel 202.

The number of rotations of the cylindrical cage may be used to control the dispensing of an expected amount of build material from a build material container. Accordingly, the motor 316 may be a stepper motor, a servo motor, or other type of motor that may be used to control the number of revolutions and the speed of the rotation. In some examples, a motor having a controlled speed, such as a motor control using pulse width modulation or pulse frequency modulation, may be used with a sensor that counts the number of revolutions. For example, a base position sensor as described herein may be used to count the revolutions.

The 3D printer 300 may include a recycle supply station 114 to hold a build material container for recycled material. As described for the new supply station 112, the recycle supply station 114 may include several sensors and actuators to determine if a build material container is present, and control the dispensing of recycled build material from the build material container, for example, into a recycled material vessel. The sensors may include a weighing device 318 that may be used to determine the weight of the recycle supply station 114 and a build material container. The actuators may include a motor 320 to rotate the cylindrical cage in a first angular direction to dispense build material to the recycle material vessel 208. The recycle supply station 114 may also rotate the cylindrical cage in a second angular direction, opposite the first angular direction, to add recovered or recycled material to the build material container.

The new supply station 112 and the recycle supply station 114 may also include several other sensors and actuators 322 to provide functionality, as described in greater detail herein. The other sensors and actuators 322 may include a latching sensor to determine if a build material container is secured in a supply station, and a position sensor to determine if a build material container is in a base position, among others. As used herein, a base position is an initial position of the build material container after insertion into a supply station 112 or 114. In the base position, sensors and actuators 322 on a support structure may interact with the cylindrical cage. Further, the sensors and actuators 322 may include actuators to actuate a valve on the build material container, for example, opening or closing the valve, or advance the read head to an information chip on a build material container, among others.

As described herein, the printer 300 may include a recovered material vessel 212 which discharges recovered material 216 through a recovery feeder 214 into the first conveying system 302. The recovered material vessel 212 may have a weight sensor 324 and a fill level sensor 326. Accordingly, the build material 328 may include recovered material 216 from the recovered material vessel 212 in addition to the recycle material from the recycle material vessel 208 and new material from the new material vessel 202.

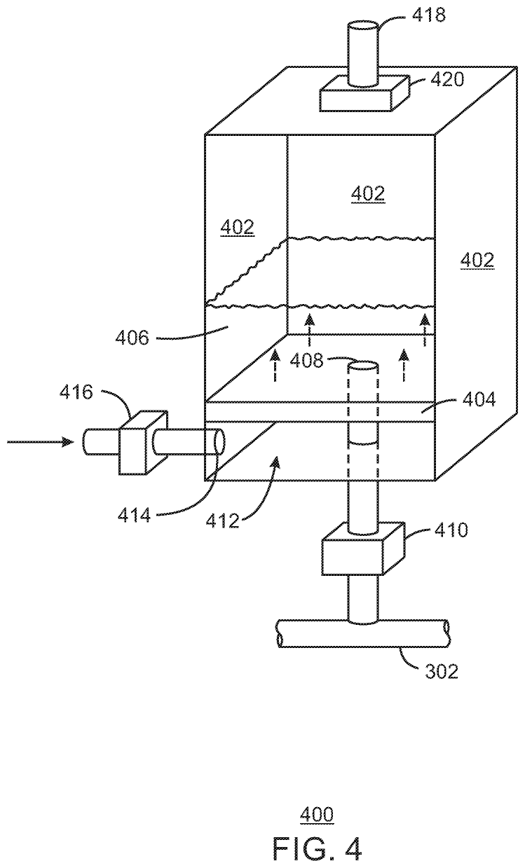

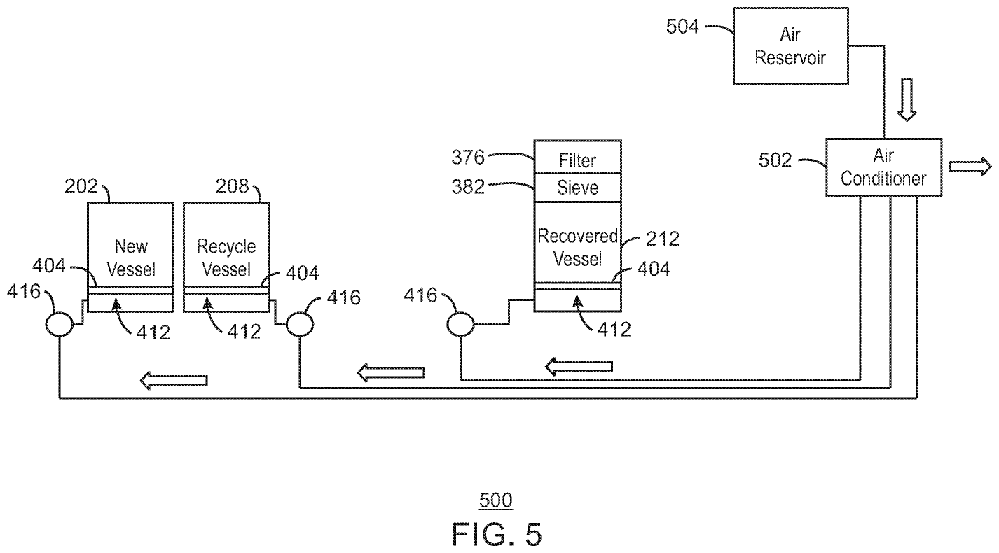

Air flowing into the new vessel 202, the recycle vessel 208, and the recovered vessel 212 is provided by an air intake system, which includes an air conditioner (not shown) such as a humidifier or dehumidifier. For the sake of clarity, components of the air intake system are shown separately in FIGS. 4 and 5. The first conveying system 302 may transport the build material 328, e.g., a mix of new material, and recycle material from the vessels 202 and 208, respectively. In some instances, the build material 328 may also include recovered material 216. In the illustrated example, the first conveying system 302 may convey the build material 328 to a separator 330 associated with a dispense vessel 332. The dispense vessel 332 may be a feed hopper. The separator 330 may include a cyclone, a screen, a filter, and the like. The separator 330 may separate conveying air 334 from the build material 328.

After the conveying air 334 has been separated, the build material 328 may flow into the dispense vessel 332. A feeder 336 may receive build material from the dispense vessel 332 and discharge the build material to a build material handling system 338 for the 3D printing. The dispense vessel 332 may have a fill level sensor 340. The fill level sensor 340 may measure and indicate the level or height of build material in the dispense vessel 332.

The first conveying system 302 may divert build material 328 via a diverter valve 342. The diverted material 344 may be sent to an alternate vessel 346 through a separator 348 such as cyclone, filter, etc. The alternate vessel 346 may discharge the diverted material 344 through a feeder 350 and diverter valve 352 to either a build material container in the supply station 114, or to the recycle material vessel 208. As described in examples herein, the diverter valve 352 may be part of a valve mechanism used to dispense recycled build material from a build material container.

This diversion of build material 328 by diverter valve 342 as recycle material 344 may occur, for instance, when the build material 328 is primarily recycle material or recovered material 216. This may be performed to offload material, for example, by diverting the material through diverter valve 352 to a build material container. In other examples, the recycle material 344 may be sent by the diverter valve 352 to the recycle material vessel 208. As with other material vessels, the alternate vessel 346 may have a fill level sensor 354.

The separator 348 associated with the alternate vessel 346 may remove conveying air 356 from the build material 328. After the conveying air 356 is removed from the build material 328, the build material 328 may discharge from the separator 348 into the alternate vessel 346. In the illustrated example, the conveying air 356 from the separator 348 may flow to a Y-fitting 358, where the conveying air 356 is combined with the conveying air 334 from the separator 330 associated with the dispense vessel 332. The Y-fitting 358 may be a conduit fitting having two inlets and one outlet. The combined conveying air 360 may be pulled from the Y-fitting 358 by a motive component 362 of the first conveying system 302 and discharged 364 to the environment or to additional equipment for further processing. In some examples, the combined conveying air 360 may flow through a filter 366 as it is being pulled out by the motive component 362. The filter 366 may remove particulates from the conveying air 360 before it is discharged 364.

The motive component 362 applies motive force for the conveying air in the first conveying system 302 to transport build material. The motive component 362 may be an air blower, eductor, ejector, vacuum pump, compressor, or other motive component. Because the first conveying system 302 is generally a pneumatic conveying system, the motive component may typically include a blower such as a centrifugal blower, fan, axial blower, and the like.

As for the 3D printing, as mentioned, the dispense vessel 332 may discharge the build material 328 through a feeder 336 to the build material handling system 338. The feeder 336 and the build material handling system 338 may provide a desired amount of build material 328 across a build platform 368, for example, in layers. The build material handling system 338 may include a feed apparatus, dosing device, build-material applicator, or powder spreader, and the like, to apply the build material to the build platform 368 in the build enclosure 370. The printer 300 may form a 3D object from build material 328 on the build platform 368.

After the 3D object is complete or substantially complete on the build platform 368, a vacuum manifold 372 may remove excess build material from the build enclosure 370 into a second conveying system 374 as recovered material. In some examples, a second conveying system 374 is not used. For example, the excess build material may be off-loaded with the 3D object or removed by a stand-alone vacuum.

If the second conveying system 374 is used, it may convey the recovered material through a cyclone or filter or settling chamber 376 to separate the recovered material from the conveying air 378. The conveying air 378 is discharged through a motive component 380 of the second conveying system 374. A filter may be included to remove particulates that do not settle out from the conveying air 378. The motive component 380 may be a blower, fan, eductor, ejector, vacuum pump, or other type of motive component. In this example, the recovered material may discharge from the cyclone, settling chamber, or filter 376 and enter a sieve 382 where larger particles, such as solidified build material not incorporated into the 3D object, may be removed. The sieve 382 may have a fill level sensor 384 which monitors the level or height of solid material in the sieve 382.

After separation of the larger particles, the recovered build material may enter the recovered material vessel 212. The vessels, conveying systems, and associated equipment of the 3D printer 300 may include instrumentation such as pressure sensors and temperature sensors, and the like.

The 3D printer 300 may fabricate objects as prototypes or products for aerospace (e.g., aircraft), machine parts, medical devices (e.g., implants), automobile parts, fashion products, structural and conductive metals, ceramics, and so forth. In one example, the 3D objects formed by the 3D printer 300 are mechanical parts which may be metal or plastic, and which may be equivalent or similar to mechanical parts produced by other fabrication techniques, for example, injection molding or blow molding, among others.

Examples provided herein describe supply stations for moving build material into and out of a 3D printer. The material may be provided in build material containers, which may be purchased with new build material and used for recycle build material once empty. For further flexibility, build material containers may be purchased when empty to store build material offloaded from the 3D printer. This may be convenient when changing the type of build material used in the 3D printer.

To perform these functions, a build material container may be horizontally, or substantially horizontally, secured in a cylindrical cage supported in a stationary support structure in the supply station. The supply station may open a valve in a center of an end of the build material container by sliding the valve outward along a horizontal axis. The supply station may then move material in or out of the build material container by rotating, in an appropriate direction, the cylindrical cage around the horizontal axis. Rotating the cylindrical cage in a first angular direction may be used to dispense build material from a build material container, while rotating the cylindrical cage in a second, or opposite, angular direction may be used to add build material back into the build material container.

As mentioned above, the 3D printer also includes an air intake system coupled to the new vessel 202, the recycle vessel 208, and the recovered vessel 326. The air intake system is described further below in relation to FIGS. 4 and 5.

FIG. 4 is a drawing of a build material vessel, in accordance with examples. The build material vessel 400 can be used as the new vessel 202, the recycle vessel 208, the recovered vessel 326, or any combination thereof. As shown in FIG. 4, the build material vessel 400 includes side walls 402 and a build material bed 404 to contain and support the build material 406. For the sake of clarity, the forward-facing side wall is removed to show internal components of the build vessel 400. Additionally, other shapes of the build vessel 400 are possible, including cylindrical.

The build material bed 404 contains an aperture 408 that enables the build material 406 to drain out of the build material vessel 400 under the control of a feeder 410 such as a rotary feeder, auger, or screw feeder. In some examples, the build material bed 404 may be sloped toward the aperture 408 to help guide the build material 406 toward to the aperture 408. The feeder 410 discharges the build material into the conveying system 302.

The build material vessel 400 includes an air flow chamber 412 disposed below build material bed 404. The air flow chamber 412 receives a flow of air from the air intake system through an air intake aperture 414. As described further in relation to FIG. 5, the air intake system includes an air conditioner (not shown) that provides a controlled level of humidity to the air flowing into the air flow chamber 412. In some examples, an air pressure generator 416 may be coupled to the air intake aperture 414 to increase the flow of air into the air flow chamber 412. The pressure generator 300 may be a pump, a fan, a blower, or the like.

The build material bed 404 comprises a porous membrane that allows air and moisture to flow up from the air flow chamber 412 through build material 406. The porous membrane is configured to provide a uniform flow of air across the surface area of the porous membrane while preventing build material 406 from falling into the air chamber 412. The porous membrane may be formed from any suitable material including polyethylene, metal, plastic, combinations thereof, and the like. In some examples, the porous membrane is formed from an Ultra High Molecular Weight Polyethylene (UHMWPE). The thickness of the porous membrane may be selected to provide proper support for the build material 406 and may be determined based on the composition of the porous membrane and the type and amount of build material 406 to be supported.

The pore size of the porous membrane may be selected to be sufficient for preventing the build material 406 from entering and/or blocking the pores or flowing through the porous membrane into the air flow chamber 412. In some examples, the pores may have sizes that are between about 5 to 10 microns and include a density of about 10 to 30 percent of the total volume of the porous membrane.

The porous membrane is also configured to ensure that the air flow is substantially uniform across the surface of the porous membrane. In some examples, the pores or channels in the porous membrane follow meandering paths from one side of the porous membrane to the other rather than a direct vertical path. To accomplish this, the porous membrane may be formed by bonding beads of material together with an adhesive or through partially melting of the beads, which may have spherical shapes. As another example, the porous membrane may be an open cell foam that forms a mesh of connected pores. Other compositions for the porous membrane are also possible.

The air flow through the porous membrane will be at a velocity sufficient to fluidize the build material. Fluidization refers to a stimulation of the build material 406 that causes it to exhibit the flow properties of a fluid. The fluidization caused by the air flow stimulates the flow of build material 406 from the build material vessel 400 through the feed aperture 408 and into the conveying system 302. The fluidizing air may also cause the build material 406 to circulate within the build material vessel 400, causing the build material to mix together.

In addition to fluidizing the build material 406, the air flowing through the porous membrane of the build material bed 404 also controls the level of moisture content in the build material 406. The humidity of the air flowing into the build material vessel may be controlled to maintain a desired level of moisture content, either by adding moisture to the build material 406 or removing moisture from the build material 406. The desired level of moisture content may be determined based on a number of factors, including the type of build material, the temperature of build material, and others. The type of build material affects its ability to absorb bulk moisture as well surface moisture. Factors affecting moisture absorption and desorption rates include the base material chemistry, surface chemistry, powder additives, surface morphology (i.e., area and shape), and surface energy. Exposure time and temperature also effect the amount of moisture absorbed. In some cases it might take several hours to condition the build material.

Additionally, the build material vessel 400 may also include an exhaust outlet 418 for allowing excess air to escape. The exhaust outlet 418 can include a filter 420 to keep build material out of the exhaust air.

FIG. 5 is an air intake system for a 3D printer, in accordance with examples. The air intake system 500 is configured to provide air to various components of a 3D printer with a controlled humidity level. In the example shown in FIG. 5, the air intake system 500 provides dried or humidified air to the new vessel 202, the recycle vessel 208, and the recovered vessel 212, each of which is described in greater detail in relation to FIG. 4. As described in relation to FIG. 4, the air provided by the air intake system 500 is delivered to an air flow chamber 412 disposed below the build material bed 404, which includes the porous membrane. It will be appreciated that the intake air system 500 can provide air to more or fewer vessels, depending on the design considerations of a particular implementation.

The air intake system 500 includes an air conditioner 502. As used herein the term “air conditioner” refers to a system that is able to control the humidification level of an output air supply. The air conditioner 502 may be a humidifier, a dehumidifier, or a combination humidifier and dehumidifier. Additionally, the term “humidity level” and variations thereof can be used to refer to a high level of humidity or a low level of humidity, including substantially dry. Thus, controlling the humidity level of the air should not be interpreted to mean that water vapor is necessarily being added to the air. Rather, controlling the humidity level of the air can refer to adding water vapor or removing water vapor.

The air conditioner 502 receives air from an air reservoir 504, which may be configured to draw in ambient air through a filter. The air conditioner 502 then conditions the air and outputs the conditioned air to the new vessel 202, the recycle vessel 208, and the recovered vessel 326. The air flow through the air intake system may be created, at least in part, by one or more air pressure generators 416 coupled to the build material vessels 202, 208, and 212. In some examples, the air flow is created by the humidifier 502 itself or additional motive components, such as motive components 362 and 380 shown in FIG. 3.

The air conditioner 502 operates to either increase the humidity level of the output air or to dry the output air, depending on the desired moisture content of the build material in the build material vessels 202, 208, and 212. The humidity of the output air may be controlled to add humidity to the ambient air or to remove humidity from the ambient air depending on the desired level of moisture content in the build material. In some examples, the desired level of moisture content is a high level of moisture content that is still low enough to prevent condensation of water in the build material and the conveying path for the air between the air conditioner and the build material vessel. In some examples, the humidity of the air flowing into the build material vessels 202, 208, and 212 can be maintained at a level such that the dew point of the air inside each vessel is below the temperature of the air inside the vessels by a suitable safety margin. In some examples, the desired level of moisture content is a low level of moisture content, for example, substantially dry or close to no moisture content. Controlling the humidity of the air flowing into the build material vessel also prevents condensation of water inside the porous membrane, which is at roughly the same temperature as the build material.

The humidity level of the air output by the air conditioner 500 may be set manually by an operator of the 3D printer. For example, the operator can set the air conditioner 502 to a predetermined humidification level known to provide the correct amount of moisture content to the build material, or the operator can set the air conditioner 502 to provide substantially dry air to dry the build material. In some examples, the humidification level provided by the air conditioner 502 may be controlled automatically, for example, by the controller 312 (FIG. 3). To maintain the desired humidity level, the controller 312 may receive data from sensors (not shown) that measure one or more characteristics of the output air, the build material, or both, including temperature, relative humidity of the air inside the build material vessel, moisture content of the build material, flow characteristics of the build material, and the like.

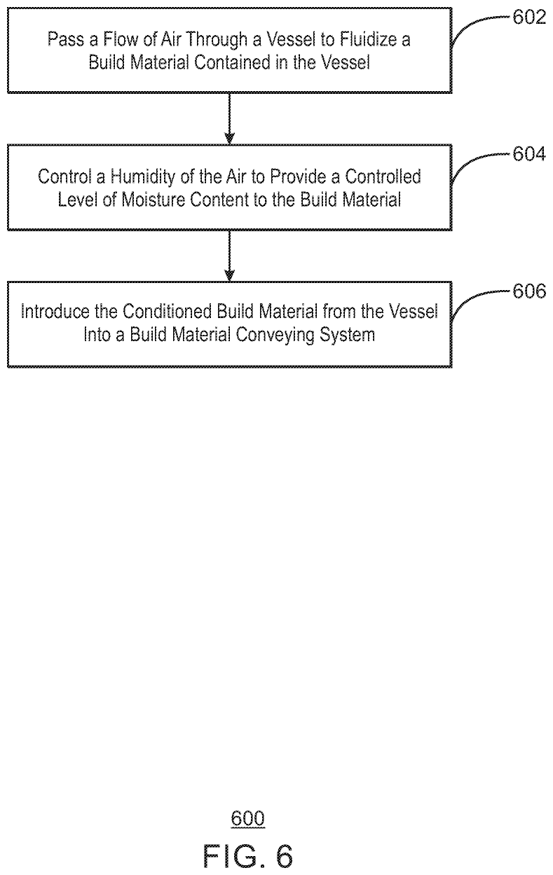

FIG. 6 is a block diagram of summarizing a method 600 for operating a 3D printer, in accordance with examples. The method 600 may begin at block 602. At block 602, a flow of air is passed through a build material vessel to fluidize the build material contained in the vessel. At block 604, the humidity of the air is controlled to provide a controlled level of moisture content to the build material. The humidity of the air can be controlled to increase the moisture content of the build material or to reduce the moisture content of the build material. In either case, the humidity of the air can also be controlled to prevent condensation of water in the build material. In some examples, the controlled level of moisture content is based on the build material type and/or the temperature of the build material. At block 606, the conditioned build material is introducing from the vessel into a build material conveying system for transportation to a build enclosure in which a three-dimensional object is printed.

The method 600 should not be interpreted as meaning that the blocks are necessarily performed in the order shown. Furthermore, fewer or greater actions can be included in the method 600 depending on the design considerations of a particular implementation.

While the present techniques may be susceptible to various modifications and alternative forms, the examples discussed above have been shown by way of example. It is to be understood that the techniques are not intended to be limited to the particular examples disclosed herein. Indeed, the present techniques include all alternatives, modifications, and equivalents falling within the scope of the present techniques.

What is claimed is:

1. A system for controlling moisture content of build material in a three dimensional printer, comprising:
a vessel to supply the build material into a build material conveying system, wherein the vessel comprises an air inlet to receive a flow of air to fluidize the build material; and
an air conditioner to control the humidity of the air and provide a controlled level of moisture content to the build material.

2. The system of claim 1, wherein the vessel comprises a porous membrane to distribute the flow of air throughout the build material contained in the vessel.

3. The system of claim 1, wherein the humidity of the air is controlled to increase the moisture content of the build material.

4. The system of claim 1, wherein the humidity of the air is controlled to reduce the moisture content of the build material.

5. The system of claim 1, wherein the controlled level of moisture content is based on the build material type.

6. A method for manufacturing three dimensional objects comprising:
passing a flow of air through a vessel to fluidize a build material contained in the vessel;
controlling humidity of the air to provide a controlled level of moisture content to the build material; and
introducing the build material from the vessel into a build material conveying system.

7. The method of claim 6, wherein the humidity of the air is controlled to increase the moisture content of the build material.

8. The method of claim 6, wherein the humidity of the air is controlled to reduce the moisture content of the build material.

9. The method of claim 6, wherein the humidity of the air is controlled to prevent condensation of water in the build material and the build material conveying system.

10. The method of claim 6, comprising transporting the build material through the conveying system to a build enclosure and generating a three-dimensional object from the build material.

11. A three-dimensional printer, comprising:
a vessel to supply the build material into a build material conveying system, wherein the vessel comprises an air inlet to receive a flow of air to fluidize the build material;
an air conditioner to control the humidity of the air and provide a controlled level of moisture content to the build material; and
a build enclosure to receive the build material from the build material conveying system, wherein the three-dimensional printer forms a three-dimensional object within the build enclosure.

12. The three-dimensional printer of claim 11, wherein the vessel comprises a porous membrane to distribute the flow of air throughout the build material contained in the vessel.

13. The three-dimensional printer of claim 11, comprising a second build material conveying system to transport excess build material from the build enclosure to a recovered material vessel.

14. The three-dimensional printer of claim 11, wherein the humidity of the air is controlled to reduce the moisture content of the build material.

15. The three-dimensional printer of claim 11, wherein the humidity of the air is controlled to increase the moisture content of the build material.
